(19) United States
(12) Patent Application Publication
(10) Pub. No.: US 2008/0174575 A1
(43) Pub. Date: Jul. 24, 2008

(54) DRIVING APPARATUS FOR DISPLAY DEVICE AND DISPLAY DEVICE INCLUDING THE SAME, AND DRIVING METHOD FOR DISPLAY DEVICE

(75) Inventors: Jong-Seok CHAE, Seoul (KR); Sun-Hyung CHOI, Hwaseong-si (KR); Kil-Soo CHOI, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/848,344

(22) Filed: Aug. 31, 2007

(30) Foreign Application Priority Data
Jan. 22, 2007 (KR) 10-2007-0006473

(51) Int. Cl. G09G 5/00

(52) U.S. Cl. 345/204; 345/55

(57) ABSTRACT

A driving apparatus for a display device includes a micro processor unit (“MPU”) including a memory, the MPU provides image data and an input control signal and a signal controller including a counter, the signal controller generates an output control signal based on the input control signal, wherein the memory includes a plurality of commands and an index which assigns a first command among the plurality of commands, and the index and the plurality of commands are sequentially transmitted to the signal controller.

This application claims priority to Korean Patent Application No. 10-2007-0006473, filed on Jan. 22, 2007, and all the benefits accruing therefrom under 35 U.S.C. §119, the contents of which in its entirety are herein incorporated by reference.

### BACKGROUND OF THE INVENTION

(a) Field of the Invention

The present invention relates to a driving apparatus for a display device, a display device including the same and a driving method for tile display device. More particularly, the present invention relates to a driving apparatus for a display device, a display device including the same and a driving method for the display device capable of using less memory capacity and reducing power consumption.

(b) Description of the Related Art

Recently, flat panel display devices such as an organic light emitting diode (“OLED”) device, a plasma display panel (“PDP”) device and a liquid crystal display (“LCD”) device have been actively developed as substitutes for a cathode ray tube (“CRT”) which is heavy and large.

A PDP device displays characters or images using plasma generated by a gas-discharge, and an OLED device displays characters or images using electroluminescence of a specific organic material or high molecules. An LCD device displays desired images by applying an electric field to a liquid crystal (“LC”) layer disposed between two opposing panels and regulating a strength of the electric field to adjust a transmittance of light passing through the LC layer.

Among such flat panel displays, for example, the LCD and the OLED each includes a display panel provided with pixels including switching elements and display signal lines, a gate driver for providing gate signals to gate lines among the display signal lines in order to turn on/off the switching elements of the pixels, a gray voltage generator for generating a plurality of gray voltages, a data driver for selecting a voltage corresponding to an image data as a data voltage from the gray voltages and applying the data voltage to a data line among the display signal lines and a signal controller for controlling the above mentioned elements.

Among such display devices, a small or medium-sized display device such as a mobile phone includes a microprocessor unit (“MPU”), corresponding to a central processing unit, for receiving an image signal from an external source and a driving chip connected to the MPU for driving a display panel assembly.

The MPU includes a memory for storing a program, which is a set of commands, and the program includes commands and indexes for assigning addresses for each of the commands.

Here, the MPU alternately transmits indexes and the corresponding commands to a system-on-chip (“SoC”), and a distinction signal for the transmission repeatedly transitions between a high level signal and a low level signal. For example, the distinction signal transmits an index at a low level signal and a command at a high level signal.

Here, a current flows during the transition between the high level signal and the low level signal, that is, at a falling edge and at a rising edge. Therefore, if many rising edges and falling edges are present, that is, if there are many transitions between the high level signal and the low level signal, a power consumption increases. Also, a memory capacity increases as a result of assigning an index for each command.

### BRIEF SUMMARY OF THE INVENTION

The present invention has been made in an effort to provide a driving apparatus for a display device, a display device including the same and a driving method for the display device, all of which have advantages which include using less memory and power consumption.

An exemplary embodiment of the present invention provides a driving apparatus for a display device, the driving apparatus includes a microprocessor unit (“MPU”) including a memory, the MPU provides image data and an input control signal and a signal controller including a counter, the signal controller generates an output control signal based on the input control signal, wherein the memory includes a plurality of commands and an index which assigns a first command among the plurality of commands, and the index and the plurality of commands are sequentially transmitted to the signal controller.

The counter may receive the index and increase the index one by one, and the signal controller may sequentially receive the plurality of commands.

The index and the plurality of commands may be transmitted in synchronization with a distinction signal and a selection signal, and the index may be transmitted when the distinction signal is at a first level while the commands may be transmitted when the distinction signal is at a second level.

The index and the plurality of commands may be transmitted when the selection signal is at the first level, and the counter may count points when the selection signal transitions from the first level to the second level and then increase the index one by one.

The display device may include a display panel assembly provided with a gate line and a data line, and a gate driver which applies a gate signal to the gate line and a data driver which applies a data signal to the data line according to the output control signal.

The driving apparatus for a display device may further include a driving chip which drives the display panel assembly, wherein the driving chip includes the signal controller, the gate driver and the data driver.

The gate line may extend in a first direction and the data line may extend in a second direction, the first direction may be substantially perpendicular to the second direction.

The display device may further include a plurality of pixels, each pixel of the plurality of pixels may be electrically connected to the gate line and the data line.

An exemplary embodiment of the present invention provides a display device including a display panel assembly provided with a gate line and a data line, an MPU including a memory, the MPU provides image data and an input control signal and a signal controller including a counter, the signal controller generates an output control signal based on the input control signal, wherein the memory includes a plurality of commands and an index which assigns a first command among the plurality of commands, and the index and the plurality of commands are sequentially transmitted to the signal controller.

The counter may receive the index and increase the index one by one, and the signal controller may sequentially receive the plurality of commands.

The index and the plurality of commands may be transmitted in synchronization with a distinction signal and a selection signal, and the index may be transmitted when the distinction signal is at a first level while the commands may be transmitted when the distinction signal is at a second level.

The index and the plurality of commands may be transmitted when the selection signal is at the first level, and the counter may count points when the selection signal transitions from the first level to the second level and then increase the index one by one.

The display device may further include a gate driver which applies a gate signal to the gate line and a data driver which applies a data signal to the data line according to the output control signal.

The display device may further include a driving chip which drives the display panel assembly, wherein the driving chip may include the signal controller, the gate driver and the data driver.

Also, the driving chip may be mounted on the display panel assembly.

An exemplary embodiment of the present invention provides a driving method for a display device which includes a MPU including a memory and provides image data and an input control signal, and a signal controller including a counter and generates an output control signal based on the input control signal, wherein the memory includes a plurality of commands and an index which assigns a first command among the plurality of commands, the driving method for a display device including transmitting the index to the signal controller; transmitting a first command assigned to the index and sequentially transmitting the plurality of commands following the first command.

The counter may receive the index and increase the index one by one, and the signal controller may sequentially receive the plurality of commands.

The index and the plurality of commands may be transmitted in synchronization with a distinction signal and a selection signal, and the index may be transmitted when the distinction signal is at a first level while the plurality of commands may be transmitted when the distinction signal is at a second level.

The index and the plurality of commands may be transmitted when the selection signal is at the first level, and the counter may count points when the selection signal transitions from the first level to the second level and then increase the index one by one.

The display device may include a display panel assembly provided with a gate line and a data line, and a gate driver which applies a gate signal to the gate line and a data driver which applies a data signal to the data line according to the output control signal.

The display device may further include a driving chip which drives the display panel assembly, wherein the driving chip includes the signal controller, the gate driver and the data driver.

### BRIEF DESCRIPTION OF THE DRAWINGS

The accompanying drawings briefly described below illustrate exemplary embodiments of the present invention, and, together with the description thereof, serve to describe the above and other aspects, features and advantages of the present invention, in which.

FIG. 1 is a schematic diagram of an exemplary embodiment of a liquid crystal display (“LCD”) according to the present invention;

FIG. 2 is a block diagram of an exemplary embodiment of an LCD according to the present invention;

FIG. 3 is an equivalent circuit schematic diagram of an exemplary pixel of an exemplary LCD according to the present invention;

FIG. 4 is a schematic block diagram of a microprocessor unit (“MPU”) and an integration clip illustrated in FIG. 1;

FIG. 5 is a waveform diagram of signals illustrated in FIG. 4; and

FIGS. 6A and 6B are a conventional memory setting and a conventional waveform diagram of signals according to the prior art, respectively.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower“, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention. In the drawings, the thickness of layers, films, panels, regions, etc., are exaggerated for clarity.

The present invention will be described more fully hereinafter with reference to the accompanying drawings, in which exemplary embodiments of the invention are illustrated.

Now, a display device according to an exemplary embodiment of the present invention will be described in detail with reference to the accompanying drawings.

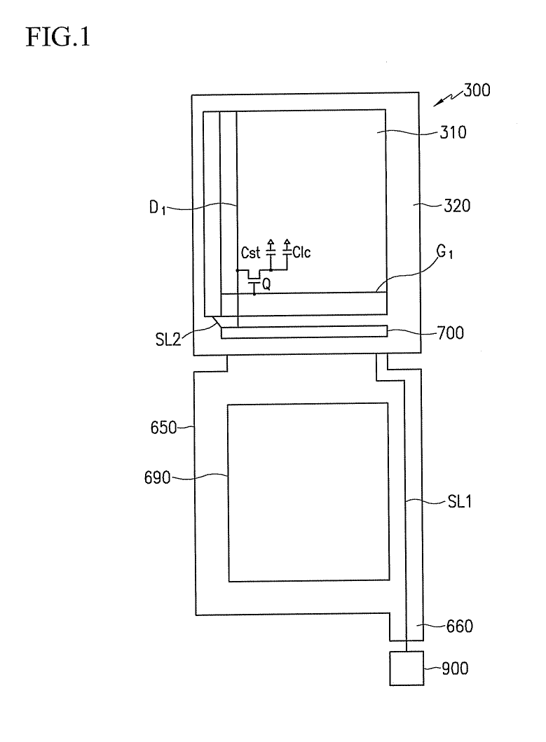

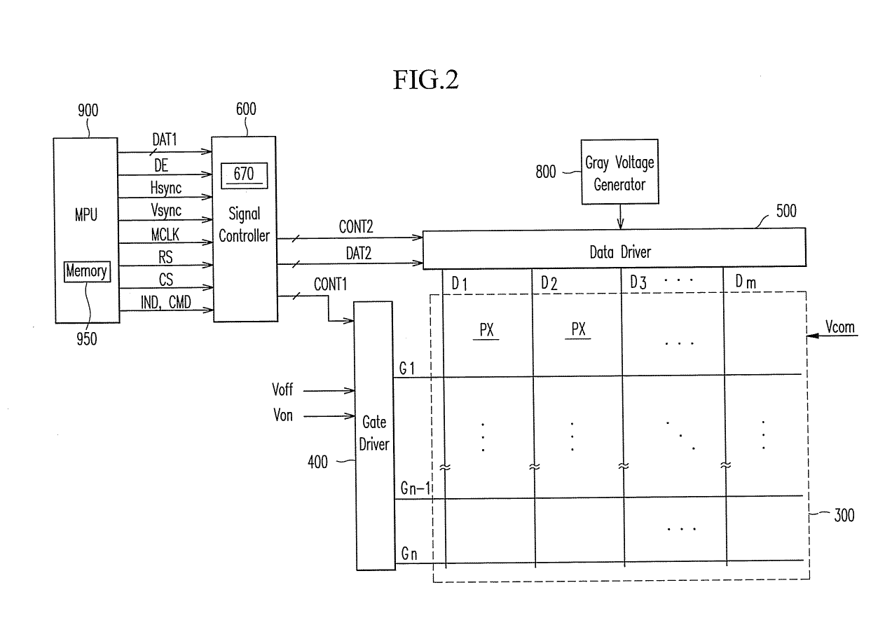

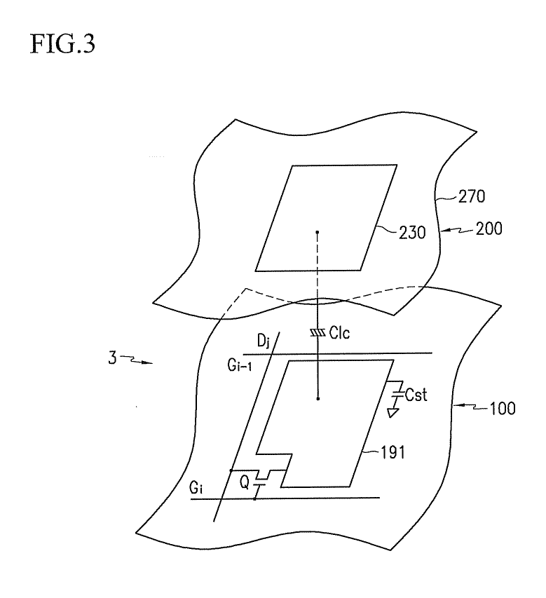

FIG. 1 is a schematic diagram of an exemplary embodiment of a liquid crystal display (“LCD”) according to the present invention, FIG. 2 is a block diagram of an exemplary embodiment of an LCD according to the present invention and FIG. 3 is an equivalent circuit schematic diagram of an exemplary pixel of an exemplary LCD according to the present invention.

Referring to FIG. 1, an exemplary LCD according to the present invention includes a display panel assembly 300, a flexible printed circuit (“FPC”) film 650 attached to the display panel assembly 300 and an integration chip 700 mounted on the display panel assembly 300.

The FPC 650 is attached to an edge of the display panel assembly 300. The FPC 650 includes an opening 690 which exposes a portion of the display panel assembly 300 when the FPC 650 is folded in an assembled state. An input section 660 to which a signal from an external source is inputted is provided below the opening 690, and a plurality of signal lines SL1 and SL2 which electrically connects the input section 660 to the integration chip 700 and the integration chip 700 to the display panel assembly 300 is provided, wherein a width of the signal lines SL1 and SL2 becomes substantially wider at a place where the signal lines SL1 and SL2 connect to the integration chip 700 and attach to the display panel assembly 300 to form pads (not shown). The display panel assembly 300 and the FPC 650 are attached to each other by using an anisotropic conductive layer (not shown) for electrical connection to the pads. In the current exemplary embodiment, the signal line SL1 is connected to a microprocessor unit (“MPU”) 900 to transmit various signals to the integration chip 700.

The display panel assembly 300 includes a display area 310 forming a screen and a peripheral area 320. In exemplary embodiments, the peripheral area 320 may be provided with a light blocking layer (not shown), such as a black matrix. The FPC 650 is attached to the peripheral area 320.

As illustrated in FIG. 2, the display panel assembly 300 includes a plurality of display signal lines including a plurality of gate lines G₁-Gₙ and a plurality of data lines D₁-Dₘ, and a plurality of pixels PX connected to the display signal lines and arranged substantially in a matrix, wherein a majority of the pixels PX and the display signal lines G₁-Gₙ and D₁-Dₘ are disposed in the display area 310.

The display signal lines G₁-Gₙ and D₁-Dₘ include a plurality of gate lines G₁-Gₙ for transmitting gate signals (also referred to as “scanning signals”) and a plurality of data lines D₁-Dₘ for transmitting data signals. The gate lines G₁-Gₙ extend substantially in a first direction, such as a row direction, and are substantially parallel to each other, and the data lines D₁-Dₘ extend substantially in a second direction, such as a column direction, and are substantially parallel to each other. The first direction may be substantially perpendicular to the second direction. Similar to the signal lines SL1 and SL2, a width of the display signal lines G₁-Gₙ and D₁-Dₘ becomes substantially wider at a place where the signal lines SL1 and SL2 connect to the integration chip 700, to thereby form pads (not shown).

In an exemplary embodiment, each pixel PX, for example the pixel PX connected to an i-th (i=1, 2, n) gate line Gᵢ and a j-th (j=1, 2, m) data line Dⱼ, includes a switching element Q connected to the display signal lines Gᵢ and Dⱼ and a liquid crystal (“LC”) capacitor Clc, and a storage capacitor Cst connected to the switching element Q. In alternative exemplary embodiments, the storage capacitor Cst may be omitted as necessary.

Referring to FIG. 3, the switching element Q, including a thin film transistor (“TFT”), is a three-terminal element provided on a lower panel 100. The switching element Q includes a control terminal, such as a gate electrode, connected to the gate line Gᵢ, an input terminal, such as a source electrode, connected to the data line Dⱼ and an output terminal, such as a drain electrode, connected to a LC capacitor Clc and a storage capacitor Cst.

The LC capacitor Clc includes a pixel electrode 191, as a first terminal, provided on the lower panel 100 and a common electrode 270, as a second terminal, provided on an upper panel 200, and an LC layer 3 disposed in between the pixel electrode 191 and the common electrode 270 functions as a dielectric of the LC capacitor Clc. In exemplary embodiments, the pixel electrode 191 is connected to the switching element Q, and the common electrode 270 is formed on a portion of or on an entire surface of the upper panel 200 and is supplied with a common voltage Vcom. In alternative exemplary embodiments, the common electrode 270 may be provided on the lower panel 100, and at least one of the pixel electrode 191 and the common electrode 270 may include a shape of a bar or a stripe.

The storage capacitor Cst, which functions as an auxiliary capacitor for the LC capacitor Clc, is formed by overlapping a separate signal line (not shown) which is provided on the lower panel 100 with the pixel electrode 191 via an insulator disposed therebetween, and the separate signal line is supplied with a predetermined voltage, such as a common voltage Vcom. In alternative exemplary embodiments, the storage capacitor Cst may be formed by overlapping the pixel electrode 191 with an upper previous gate line Gᵢ₋₁ disposed directly thereabove via an insulator.

In order to implement a color display, each pixel PX uniquely displays one of primary colors (e.g., spatial division) or each pixel PX sequentially displays the primary colors in turn (e.g., temporal division) such that a spatial or temporal sum of the primary colors is recognized as a desired color. In an exemplary embodiment, a set of the primary colors includes three primary colors of red, green and blue. FIG. 3 illustrates an exemplary embodiment of the spatial division in which each pixel PX includes a color filter 230 representing one of the primary colors in an area of the upper panel 200 facing the pixel electrode 191. In alternative exemplary embodiments, the color filter 230 may be provided on or under the pixel electrode 191 provided on the lower panel 100.

In exemplary embodiments, one or more polarizers (not shown) are provided in the display panel assembly 300.

Referring to FIG. 2 again, a gray voltage generator 800 generates all gray voltages or a limited number of gray voltages (hereinafter referred to as “reference gray voltages”) related to a transmittance of the pixels PX. The reference gray voltages may include gray voltages which include a positive value and gray voltages which include a negative value with respect to the common voltage Vcom.

The gate driver 400 is connected to the gate lines G₁-Gₙ of the display panel assembly 300 and synthesizes a gate-on voltage Von and a gate-off voltage Voff to generate gate signals, which are then applied to the gate lines G₁-Gₙ.

The data driver 500 is connected to the data lines D₁-Dₘ of the display panel assembly 300, and selects reference gray voltages supplied from the gray voltage generator 800 and then applies the selected reference gray voltages to the data lines D₁-Dₘ as data voltages. However, in a case when the gray voltage generator 800 supplies only a limited number of reference gray voltages rather than supplying all the reference gray voltages, the data driver 500 divides the reference gray voltages in order to generate desired data voltages.

A signal controller 600, which includes a counter 670, controls the gate driver 400 and the data driver 500.

The integration chip 700 receives a signal from the MPU 900 through the signal line SL1, and applies a processed signal to the display panel assembly 300 through the wiring disposed in the peripheral area 320 of the display panel assembly 300 to control elements such as the gate driver 400, the data driver 500, the gray voltage generator 800 and the signal controller 600, as illustrated in FIG. 2.

The display operation of such an exemplary LCD will now be described in more detail below.

The MPU 900 provides various input control signals including a data enable signal DE, a horizontal synchronization signal Hsync, a vertical synchronization signal Vsync, a main clock signal MCLK, a distinction signal RS, a selection signal CS, an index IND and a command CMD along with image data DAT1 to the signal controller 600.

The signal controller 600 receives input image data DAT1 and input control signals such as the vertical synchronization signal Vsync, the horizontal synchronization signal Hsync, the main clock signal MCLK, the data enable signal DE, a distinction signal RS, a selection signal CS, the index IND and the command CMD which controls the display of the image data DAT1 from the MPU 900. Then, based on the input control signals and the input image data DAT1, the signal controller 600 generates gate control signals CONT1 and data control signals CONT2, and processes the input image data DAT1 to be suitable for the operating condition of the display panel assembly 300, and then transmits the gate control signals CONT1 to the gate driver 400 and transmits the processed image data DAT2 and the data control signals CONT2 to the data driver 500.

The gate control signals CONT1 include a scanning start signal STV which instructs to start outputting a gate-on voltage Von, a gate clock signal CPV which controls an output time of the gate-on voltage Von and an output enable signal OE which defines a duration of the gate-on voltage Von.

The data control signals CONT2 include a horizontal synchronization start signal STH which indicates a start to input image data DAT2, a load signal LOAD which instructs to apply the corresponding data voltages to the data lines D₁-Dₘ, an inversion signal RVS which reverses a polarity of the data voltages with respect to the common voltage Vcom (hereinafter, the polarity of the data voltage with respect to the common voltage Vcom is referred to as the polarity of the data voltage) and a data clock signal HCLK.

In response to the data control signals CONT2 from the signal controller 600, the data driver 500 sequentially receives the image data DAT2 corresponding to a row of pixels PX and selects reference gray voltages corresponding to the respective image data DAT2 among the reference gray voltages from the gray voltage generator 800, and then converts the image data DAT2 into corresponding data voltages, which are then applied to the data lines D₁-Dₘ.

The gate driver 400 applies the gate-on voltage Von to the gate lines G₁-Gₙ in response to the gate control signals CONT1 from the signal controller 600, to thereby turn on the switching elements Q connected to the gate lines G₁-Gₙ. Then, data voltages applied to the data lines D₁-Dₘ are applied to the corresponding pixels PX through the turned-on switching elements Q.

A difference in voltage between a data voltage applied to a pixel PX and the common voltage Vcom appears as a charge voltage of the LC capacitor Clc, that is, a pixel voltage. An arrangement of LC molecules disposed in the LC layer 3 varies depending on an intensity of the pixel voltage. Accordingly, a polarization of light passing through the LC layer 3 varies. As a result, the transmittance of light is varied by the polarizer attached to the lower panel 100 and the upper panel 200.

After 1 horizontal period (or “1H”, a period of the horizontal synchronization signal Hsync, the data enable signal DE and the gate clock signal CPV), a data driver 500 and a gate driver 400 repeat the same procedure for a next row of pixels PX. In this manner, all of the gate lines G₁-Gₙ are sequentially supplied with the gate-on voltage Von during a frame, thereby applying data voltages to all pixels PX. Particularly, when the next frame starts after one frame is finished, the inversion signal RVS applied to the data driver 500 is controlled such that the polarity of the data voltage applied to each of the pixels PX is reversed to be opposite to the polarity of the data voltage in the previous frame (which is referred to as “frame inversion”). Here, even during one frame, the polarity of the data voltages in a data line may vary (for example row inversion or dot inversion) or the polarity of the data voltages applied to a pixel row may be different from each other (for example column inversion or dot inversion) according to the characteristics of the inversion signal RVS.

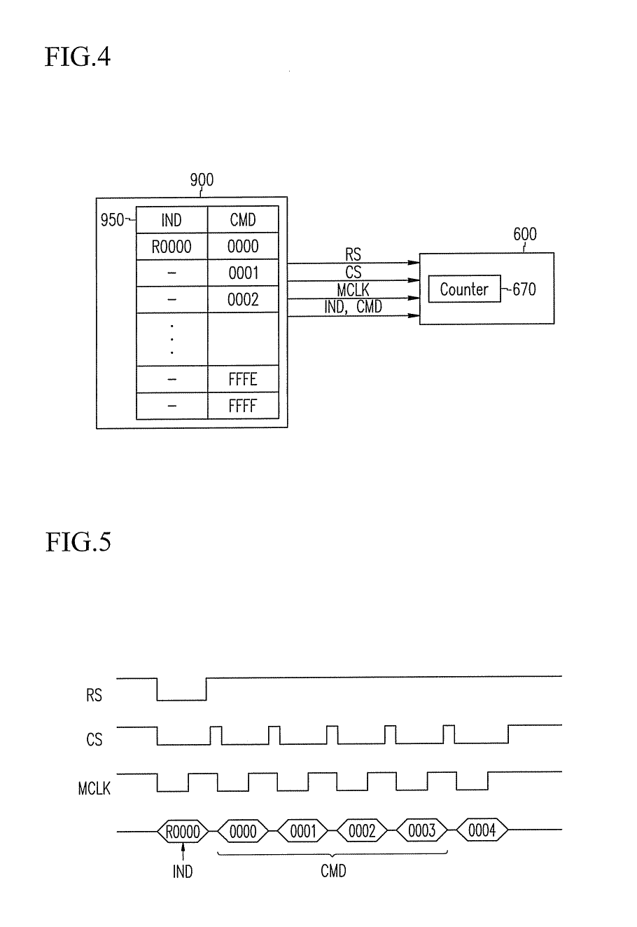

An exemplary LCD according to the present invention will now be described in more detail with reference to FIG. 4 through FIG. 6B.

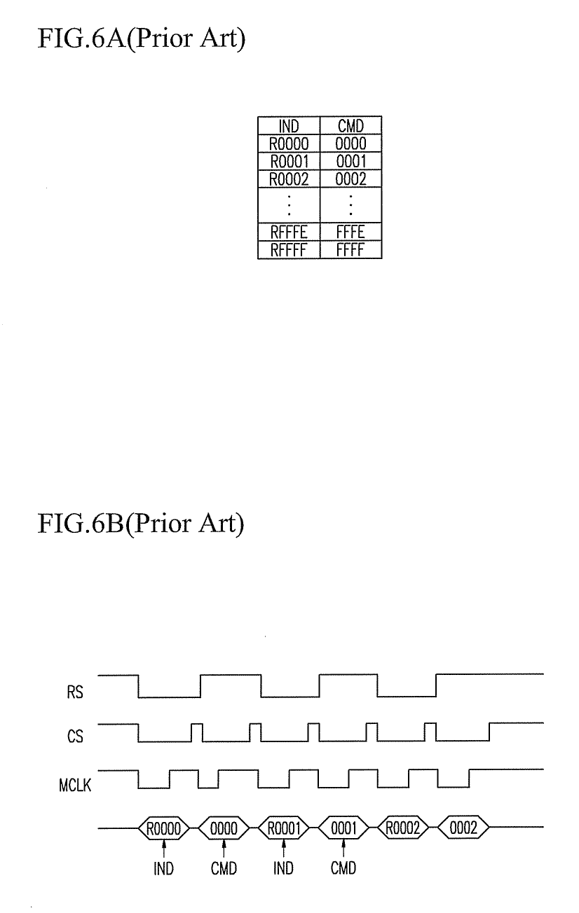

FIG. 4 is a schematic block diagram of the MPU 900 and the integration chip 700 illustrated in FIG. 1, FIG. 5 is a waveform diagram of the signals illustrated in FIG. 4 and FIG. 6A and FIG. 6B are a conventional memory setting and conventional waveform diagrams of signals in an LCD according to the prior art, respectively.

Referring to FIG. 4, the MPU 900 includes a memory 950 which stores an index IND and a plurality of commands CMD. In the schematic block diagram of FIG. 4, a 4-digit hexadecimal number illustrates an example of a command CMD.

As described above, the signal controller 600 generates various control signals, such as CONT1 and CONT2, on the basis of the commands CMD, and controls the gate driver 400, the data driver 500 and so forth.

Typically in the prior art, each of the commands CMD is assigned to an address, such as an index, in a memory and is sequentially fetched in order to complete a program.

However, in the memory 950 of an exemplary LCD according to the present invention, only one index IND R0000 which assigns an address of a first command 0000 is included. In other words, there is no corresponding index IND for each of the commands 0001-FFFF, except for the first command 0000.

As illustrated in FIG. 5, a distinction signal RS and a selection signal CS operates in synchronization with the main clock signal MCLK.

In the current exemplary embodiment, the index IND is transmitted when the distinction signal RS is at a low level, and the commands CMD are transmitted when the distinction signal RS is at a high level. Moreover, the signal controller 600 is selected when the selection signal CS, which functions as a chip selection signal, is at a low level, to thereby transmit the index IND and the commands CMD.

Therefore, since there is only one index IND, the distinction signal RS is at a low level only once and remains at a high level during the remaining section when the commands CMD are transmitted.

Meanwhile, the signal controller 600 receives the corresponding command 0000 after the counter 670 receives the index R0000. Subsequently, the counter 670 increases the index R0000 one by one by counting points when the selection signal CS transitions from a low level signal to a high level signal, that is, at the rising edges. Accordingly, the signal controller 600 receives the following command 0001 when the counter 670 adds one to the previous index R0000 as the selection signal CS transitions from the low level signal to the high level signal and also sequentially receives the remainder of the commands 0002-FFFF in a similar manner.

That is, in a display device according to an exemplary embodiment of the present invention, the distinction signal RS for transmitting the index IND is at a low level only once since there is only one index IND, and accordingly, a power consumption can be substantially decreased.

In general, current flows at a point when a signal transitions between a low level signal and a high level signal, that is, at falling edges and at rising edges, which in turn consumes power. However, in a display device according to an exemplary embodiment of the present invention, the distinction signal RS includes only one falling edge and one rising edge, such that the power consumption can be substantially decreased as compared to the prior art, which will be described more in detail below.

As shown in FIG. 6A and FIG. 6B, in a conventional memory according to the prior art, corresponding indexes IND are assigned to all commands CMD, and therefore, the distinction signal RS makes continual transitions for transmitting the indexes IND. Consequently, current flows each time there is a transition, which thereby causes an increase in the power consumption.

However, in a display device according to an exemplary embodiment of the present invention, there are only two transitions of the distinction signal RS, such that a number of transitions decreases as much as a number of the indexes IND decreases, which thereby reduces the power consumption as compared to the prior art. In addition, an amount of the selection signal CS, as well as the distinction signal RS, is also decreased as much as the number of the indexes IND decreases.

Meanwhile, in a memory of an LCD according to an exemplary embodiment of the present invention, once a first index IND is assigned, the commands CMD can then be sequentially inputted into the memory. On the contrary, in a case in which the commands are not fetched sequentially, for example, only a third command 0002 is fetched, the commands of the present invention cannot be fetched with a random access method because there is no corresponding index IND to each command. However, since typically a program, which is a set of commands, is sequentially run according to a predetermined order, the memory capacity, the amount of signals and the power consumption can be decreased by performing an exemplary embodiment of the present invention.

In this manner, power consumption can be reduced by minimizing the transitions of the distinction signal. Also, by including only the first index in a memory, the memory capacity can be decreased to thereby reduce a cost for memory.

While this invention has been described in connection with what is presently considered to be some exemplary embodiments, it is to be understood by one of ordinary skill in the art that the invention is not limited to the disclosed exemplary embodiments, but, on the contrary, is intended to cover various modifications and equivalent arrangements included within the spirit and scope of the appended claims.

What is claimed is:

1. A driving apparatus for a display device, the driving apparatus comprising:
a micro processor unit including a memory, the micro processor unit provides image data and an input control signal; and
a signal controller including a counter, the signal controller generates an output control signal based on the input control signal,
wherein the memory includes a plurality of commands and an index which assigns a first command among the plurality of commands, and
the index and the plurality of commands are sequentially transmitted to the signal controller.

2. The driving apparatus for a display device of claim 1, wherein the counter receives the index and increases the index one by one, and the signal controller sequentially receives the plurality of commands.

3. The driving apparatus for a display device of claim 2, wherein the index and the plurality of commands are transmitted in synchronization with a distinction signal and a selection signal, and
the index is transmitted when the distinction signal is at a first level while the plurality of commands are transmitted when the distinction signal is at a second level.

4. The driving apparatus for a display device of claim 3, wherein the index and the commands are transmitted when the selection signal is at the first level, and
the counter counts points when the selection signal transitions from the first level to the second level and then increases the index one by one.

5. The driving apparatus for a display device of claim 4, wherein the display device comprises:
a display panel assembly having a gate line and a data line; and
a gate driver which applies a gate signal to the gate line and a data driver which applies a data signal to the data line according to the output control signal.

6. The driving apparatus for a display device of claim 5, further comprising a driving chip which drives the display panel assembly,
wherein the driving chip includes the signal controller, the gate driver and the data driver.

7. The driving apparatus for a display device of claim 5, wherein the gate line extends in a first direction and the data line extends in a second direction substantially perpendicular to the first direction.

8. The driving apparatus for a display device of claim 5, wherein the display device further comprises a plurality of pixels, each pixel of the plurality of pixels electrically connected to the gate line and the data line.

9. A display device comprising:
a display panel assembly provided with a gate line and a data line;
a micro processor unit including a memory, the micro processor unit provides image data and an input control signal; and
a signal controller including a counter, the signal controller generates an output control signal based on the input control signal,
wherein the memory includes a plurality of commands and an index which assigns a first command among the plurality of commands, and
the index and the plurality of commands are sequentially transmitted to the signal controller.

10. The display device of claim 7, wherein the counter receives the index and increases the index one by one, and the signal controller sequentially receives the plurality of commands.

11. The display device of claim 8, wherein the index and the plurality of commands are transmitted in synchronization with a distinction signal and a selection signal, and
the index is transmitted when the distinction signal is at a first level while the plurality of commands are transmitted when the distinction signal is at a second level.

12. The display device of claim 9, wherein the index and the plurality of commands are transmitted when the selection signal is at the first level, and
the counter counts points when the selection signal transitions from the first level to the second level and then increases the index one by one.

13. The display device of claim 10, further comprising a gate driver which applies a gate signal to the gate line and a data driver which applies a data signal to the data line according to the output control signal.

14. The display device of claim 11, further comprising a driving chip which drives the display panel assembly,
wherein the driving chip includes the signal controller, the gate driver and the data driver.

15. The display device of claim 12, wherein the driving chip is mounted on the display panel assembly.

16. The display device of claim 9 further comprising a plurality of pixels, each pixel of the plurality of pixels electrically connected to the gate line and the data line.

17. A driving method for a display device which comprises a micro processor unit including a memory and provides an image data and an input control signal, and a signal controller including a counter and generates an output control signal based on the input control signal, wherein the memory includes a plurality of commands and an index which assigns a first command among the plurality of commands, the driving method for the display device comprising:
transmitting the index to the signal controller;
transmitting the first command of the plurality of commands assigned to the index; and
sequentially transmitting the plurality of commands following the first command.

18. The driving method for a display device of claim 14, wherein the counter receives the index and increases the index one by one, and the signal controller sequentially receives the plurality of commands.

19. The driving method for a display device of claim 15, wherein the index and the plurality of commands are transmitted in synchronization with a distinction signal and a selection signal, and
the index is transmitted when the distinction signal is at a first level while the plurality of commands are transmitted when the distinction signal is at a second level.

20. The driving method for a display device of claim 16, wherein the index and the plurality of commands are transmitted when the selection signal is at the first level, and
the counter counts points when the selection signal transitions from the first level to the second level and then increases the index one by one.
